(19) United States
(12) Patent Application Publication
(10) Pub. No.: US 2015/0107894 A1
(43) Pub. Date: Apr. 23, 2015

(54) HARNESS DEVICE

(71) Applicant: SUMITOMO WIRING SYSTEMS, LTD., Yokkaichi (JP)

(72) Inventors: Masashi HAYASHI, Yokkaichi (JP); Hirokazu NAKAI, Yokkaichi (JP)

(21) Appl. No.: 14/514,866

(22) Filed: Oct. 15, 2014

(30) Foreign Application Priority Data
Oct. 17, 2013 (JP) 2013-216117

(51) Int. Cl. B60R 16/02; H01B 7/00

(52) U.S. Cl. CPC B60R 16/0222; H01B 7/0045
USPC 174/72 A; 248/74.3

(57) ABSTRACT

A harness device is provided in which the number of parts is reduced. A pipe-side connecting portion of a grommet is fitted onto the outer circumferential side of an end portion of a shielding pipe, and a wire harness is inserted into the inside of the shielding pipe. A clamp member is attached to the portion in which the shielding pipe and the grommet are connected to each other. The clamp member includes a first and second divided bodies that are connected with a hinge edge so as to be capable of being opened and closed, and by closing both of the divided bodies, a tightening portion is configured to tighten the portion in which the shielding pipe and the grommet are connected to each other. The clamp member is integrally formed with an attaching portion and can be fixed to a vehicle body side.

### BACKGROUND

Exemplary embodiments relate to a harness device.

Conventionally, in hybrid vehicles and electric cars, a plurality of electric wires are routed under the floor of the vehicle between the front portion and rear portion of the vehicle. Typically, the electric wires are routed through the inside of various pipe-shaped members, as seen in a related application, JP 2012-56368A. For example, a rubber grommet is connected to a region of a corrugated tube or a metal shielding pipe in which a sealing performance is required. The electric wires that are routed through the inside of the corrugated tube or the metal shielding pipe are then routed through the grommet when passing through that region.

The grommet is connected conventionally and sealed to the shielding pipe or the corrugated tube using resin bundling tie to tighten the connecting portion of the grommet to the shielding pipe or corrugated tube or using tape. Clips for fixing the corrugated tube or the shielding pipe to the vehicle body side can also be disposed at appropriate portions in the middle part of the corrugated tube or the shielding pipe. Conventionally, the member for tightening the connecting portion (i.e., a bundling tie or a tape) and the member for fixing the corrugated tube or the shielding pipe to the vehicle body (i.e., a clip) have been dedicated members. There has been a need for the reduction of the number of parts.

### SUMMARY

Exemplary embodiments of this application were designed based on the foregoing circumstances, and it is an object to provide a harness device that reduces the number of required parts.

The harness device of exemplary embodiments includes a first member, a second member that is fitted onto and connected to an outer circumferential side of the first member, a wire harness that is inserted into an inside of the first and second members, and a clamp member that tightens both of the first and second members at a portion in which the first and second members are connected to each other, wherein the clamp member is provided with an attaching portion that can be fixed to an installation surface on which the first and second members are installed.

With exemplary embodiments, it is possible to tighten the portion in which the first and second members are connected to each other with the clamp member having the attaching portion. Accordingly, the clamp member has a function of tightening the portion in which the first and second members are connected to each other and a function of fixing those members to an installation surface, and therefore, it is possible to reduce the number of components compared with a configuration in which both functions are achieved using separate members.

### BRIEF DESCRIPTION OF THE DRAWINGS

FIG. 1 is a cross-sectional side view of a portion in which a shielding pipe and a grommet are connected to each other in Example 1.

FIG. 2 is a perspective view of a clamp member in an open state.

FIG. 3 is a cross-sectional front view of the portion in which the shielding pipe and the grommet are connected to each other.

FIG. 4 is a cross-sectional side view of the portion in which the shielding pipe and the grommet are connected to each other in Example 2.

FIG. 5 is a cross-sectional side view of the portion in which a corrugated tube and the grommet are connected to each other in Example 3.

FIG. 6 is a cross-sectional side view of the portion in which the corrugated tube and the grommet are connected to each other in Example 4.

### DETAILED DESCRIPTION OF EXEMPLARY EMBODIMENTS

Exemplary embodiments are described below.

(1) Exemplary embodiments of the harness device have a configuration in which a clamp member includes a first divided body and second divided body that are configured with a tightening portion that surrounds an entire outer circumferential portion of the second member at a portion in which the first and second members are connected to each other when the first and second divided bodies are united, and the first and second divided bodies are connected to each other with a hinge that can open and close the tightening portion.

With this configuration, the clamp member has a configuration in which the first and second divided bodies are coupled with the hinge, to reduce the number of required parts and improve handling.

(2) The second member may be formed of a rubber material, and a plurality of sealing lips that come into close contact with an outer circumferential surface of the first member may be formed on an inner circumferential surface of the second member.

With this configuration, the clamp member tightens the portion in which both pipe-shaped members are connected to each other by closing the first and second divided bodies. This allows for a substantially constant tightening force to act on the portion where the pipe-shaped members are connected. Accordingly, a substantially constant sealing force between both pipe-shaped members can be easily obtained.

(3) An exemplary embodiment of the harness device has a configuration in which a protecting portion that can cover an end surface of the second member in a circumferential direction is disposed on an inner circumferential surface of the tightening portion and projects from an end surface of the second member outwardly in an axial direction.

With this configuration, the end surface of the second member is covered with the protecting portion on the inner circumferential surface of the tightening portion of the clamp member. Accordingly, even if, for example, high-pressure washing water is blown toward the end surface of the second pipe-shaped member, high-pressure washing water hits on the protecting portion and is not directly blown against the end surface of the second pipe-shaped member. This prevents the end surface from turning up and deteriorating the sealing performance.

(4) An exemplary embodiment of the harness device may have a configuration in which a rib that presses against an outer circumferential surface of the second member is formed in a circumferential direction in a region where the sealing lips are formed on the inner circumferential surface of the tightening portion.

With this configuration, when the tightening portion tightens the portion in which both members are connected to each other, the rib presses against the region where the sealing lip is formed in the second member. This helps to improve the sealing force. Moreover, by adjusting the projecting height of the rib, it is possible to easily change the sealing force.

The following paragraphs discuss Examples 1 to 4 of the harness device in relation to the drawings.

### EXAMPLE 1

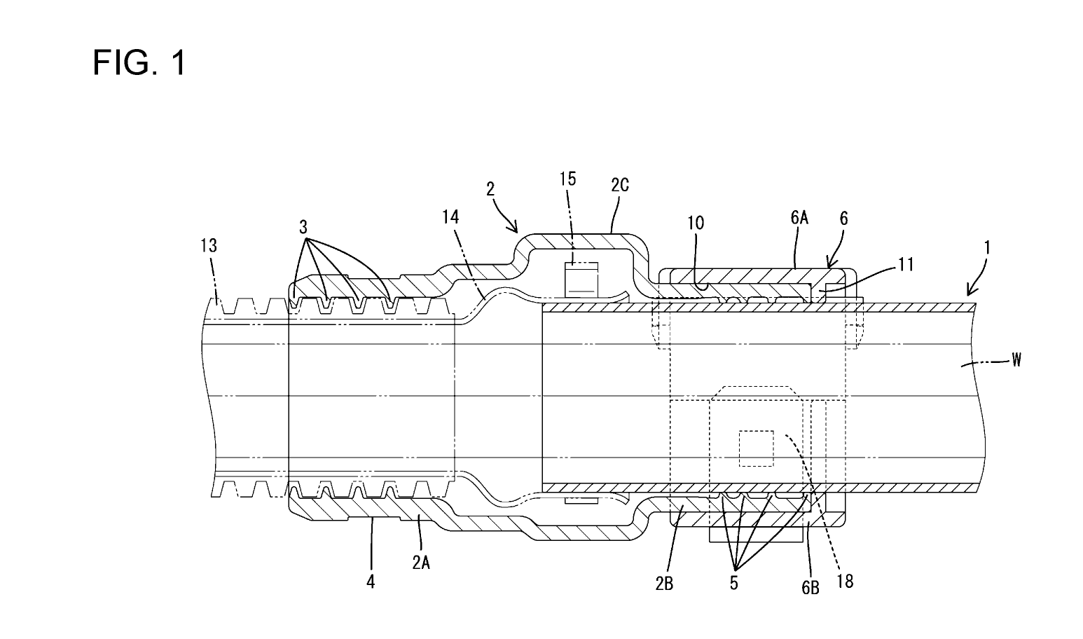

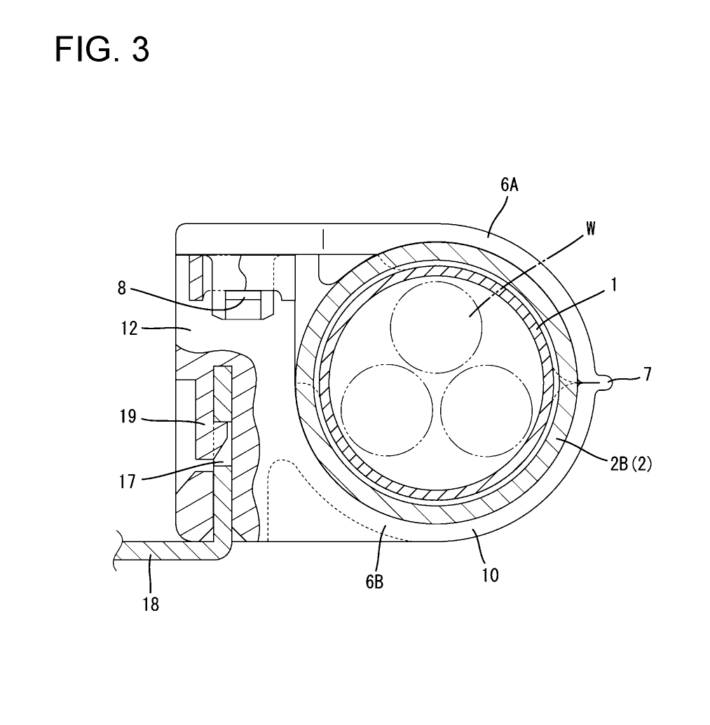

FIGS. 1 to 3 show Example 1 of the harness device. FIG. 1 is an enlarged view of the portion in which a shielding pipe 1, or second member, and a grommet 2, or second member, are connected to each other. A wire harness W connecting a battery side and an inverter side of a hybrid vehicle is inserted into the inside thereof.

The wire harness W is configured to include a plurality of high-voltage electric wires.

The shielding pipe 1 is made of metal (aluminum alloy) and is disposed along the lower surface of the floor of a vehicle. The shielding pipe 1 is formed in a long pipe shape having a circular cross section. One end portion of a braided wire 14 that shields the wire harness W toward an ECU (not shown) side is connected to the end portion of the shielding pipe 1 with a metal crimping ring 15.

The grommet 2 is formed of a rubber material in a substantially cylindrical shape. One end portion of the grommet 2 is a case-side connecting portion 2A. The end portions of a corrugated tube 13 and the braided wire 14 are inserted into the inside of the case-side connecting portion 2A and the case-side connecting portion 2A is fitted onto the outer circumferential side of the end portion of the corrugated tube 13, so that the case-side connecting portion 2A is connected thereto. A total of four sealing lips 3 project from and extend all around the inner circumferential surface of the case-side connecting portion 2A with a constant pitch. The sealing lips 3 come into close contact with the valley portions of projecting and recessed portions that are formed on the outer circumferential surface of the corrugated tube 13 and thus are sealed.

Moreover, a portion located slightly inside from the front end on the outer circumferential surface of the case-side connecting portion 2A is recessed along the entire circumference to form a recessed groove 4. The recessed groove 4 is formed in a width region between the sealing lip 3 positioned on the backmost side and one of the sealing lips 3 positioned in front of that sealing lip 3. A bundling tie (not shown) can be attached to the recessed groove 4. When the bundling tie is fastened in a state where it is positioned in the recessed groove 4, the sealing lips located at the corresponding positions are strongly compressed thereby increasing the sealing force.

The other end portion of the grommet 2 is a pipe-side connecting portion 2B and can be fitted onto the outer circumferential surface of the end portion of the shielding pipe 1 to be connected thereto. Although the outer circumferential surface of the pipe-side connecting portion 2B has no projecting and recessed portions, a total of four sealing lips 5 project from and extend all around the inner circumferential surface. The sealing lips 5 can come into close contact with the outer circumferential surface of the shielding pipe 1 in a state where the shielding pipe 1 is inserted into the pipe-side connecting portion 2B.

A large-diameter portion 2C is formed continuously from the pipe-side connecting portion 2B at the central portion of the grommet 2 and accommodates the crimping ring 15.

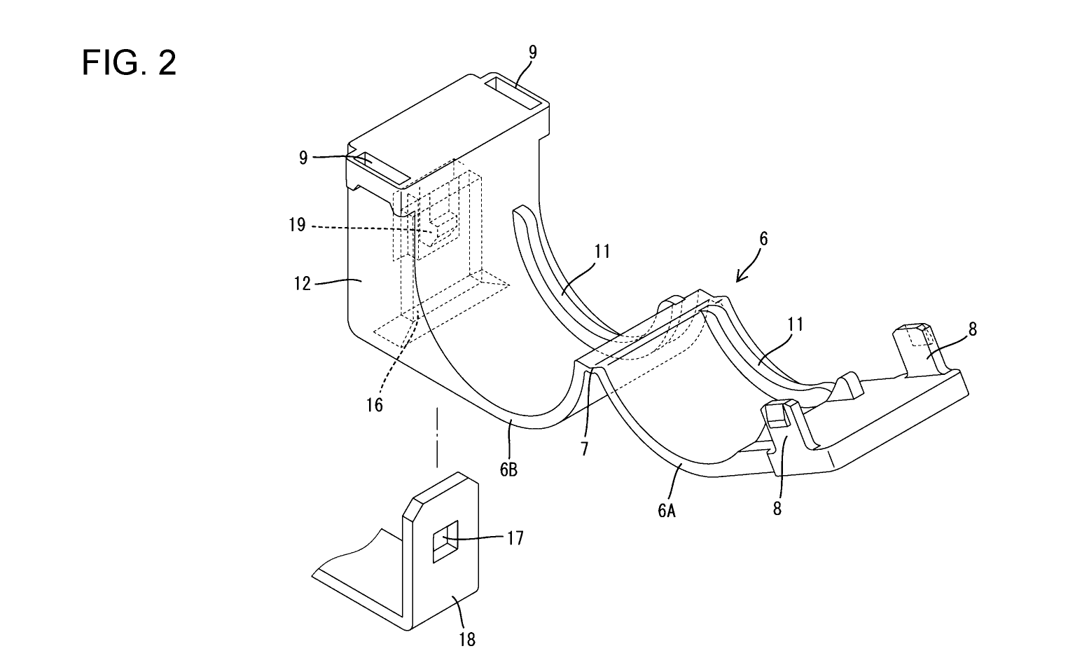

The clamp member 6 is made of a single piece of a synthetic resin material. The clamp member 6 has first divided body 6A and a second divided body 6B as shown in FIG. 2. First end portions of the first and second divided bodies 6A and 6B are connected by a hinge edge 7 so that the first and second divided bodies 6A and 6B can be opened and closed. Both divided bodies 6A and 6B have a cross section having a semicircular shape. On the other hand, a pair of locking claws 8 projects from both side edges on the free end side of the first divided body 6A, and lock-receiving portions 9 to which the locking claws 8 can be locked and unlocked are formed on the corresponding side edges of the second divided body 6B. When both of the first and second divided bodies 6A and 6B are closed, the locking claws 8 are locked to the lock-receiving portions 9, so that both divided bodies 6A and 6B are locked to each other in a joined state. Both divided bodies 6A and 613 can be joined with the above-described locking, form a tightening portion 10 having a cylindrical shape in the joined state to surround the entire circumference of the portion in which the shielding pipe 1 and the pipe-side connecting portion 2B are connected to each other, and cause a predetermined tightening force to act on that portion.

The length in an axial direction of the tightening portion 10 is set to be longer than that of the pipe-side connecting portion 2B. Accordingly, as shown in FIG. 1, one end portion of the tightening portion 10 projects from the grommet 2 in the axial direction in a state where the clamp member 6 tightens the pipe-side connecting portion 2B.

Moreover, protecting portions 11 project from a portion that is located on the inner circumferential surfaces of both divided bodies 6A and 6B, that is, the inner circumferential surface of the tightening portion 10, and that projects from the pipe-side connecting portion 2B in the axial direction when the pipe-side connecting portion 2B is tightened. When both divided bodies 6A and 6B are united, the protecting portions 11 can cover the entire circumference of the end surface of the pipe-side connecting portion 2B. The protecting portions 11 are formed in a rib shape in a circumferential direction, and front ends thereof come in substantially intimate contact with the outer circumferential surface of the shielding pipe 1. The protecting portions 11 that are configured this way to prevent high-pressure washing water from being directly blown against the front end surface of the pipe-side connecting portion 2B. The protecting portions 11 also prevent the high-pressure washing water from acting on the front end surface in a direction in which the front end surface is turned up when the high-pressure washing water infiltrates through the gap between the tightening portion 10 and the shielding pipe 1 in the axial direction.

The clamp member 6 is provided with the tightening portion 10 as well as an attaching portion 12 for fixing the clamp member 6 to a vehicle body (installation surface). An insertion port 16 is open in the lower surface of the attaching portion 12, and a bracket 18 can be inserted thereinto. The bracket is fixed to a car body, and a locking window 17 is open in the front end portion. Moreover, a locking claw 19 is formed in the attaching portion 12 so as to be flexible and locked to the locking window 17 of the bracket 18. This makes it possible to fix the clamp member 6 and in turn the entirety of the shielding pipe 1 and grommet 2 to the car body side.

Example 1 configured as described above can exhibit the following effect.

The clamp member 6 according to Example 1 is provided with the tightening portion 10 as well as the attaching portion 12. In other words, the portion in which the shielding pipe 1 and the grommet 2 are connected to each other is tightened using a member for fixing those members to the vehicle body side. This allows for a reduction in the number of required parts.

Moreover, the clamp member 6 forms a tightening portion 10 by closing the first and second divided bodies 6A and 6B and thus can fix the portion in which the shielding pipe 1 and the pipe-side connecting portion 2B of the grommet 2 are connected to each other by tightening that portion with the tightening portion 10. Since that portion is tightened by only a closing operation of the first and second divided bodies 6A and 6B at this time, it is possible to obtain a constant tightening force without having to rely on the skill of a worker. Accordingly, a stable sealing force can be obtained between the shielding pipe 1 and the grommet 2.

Furthermore, since the clamp member 6 is provided with a protecting portion 11 in this Example 1, it is possible to prevent a situation in which high-pressure washing water is directly blown against the end surface of the pipe-side connecting portion 2B. Accordingly, the end surface of the pipe-side connecting portion 2B is not displaced in a direction in which the end surface is turned up, and thus the protecting portion 11 is effective in maintaining a sealing function.

### EXAMPLE 2

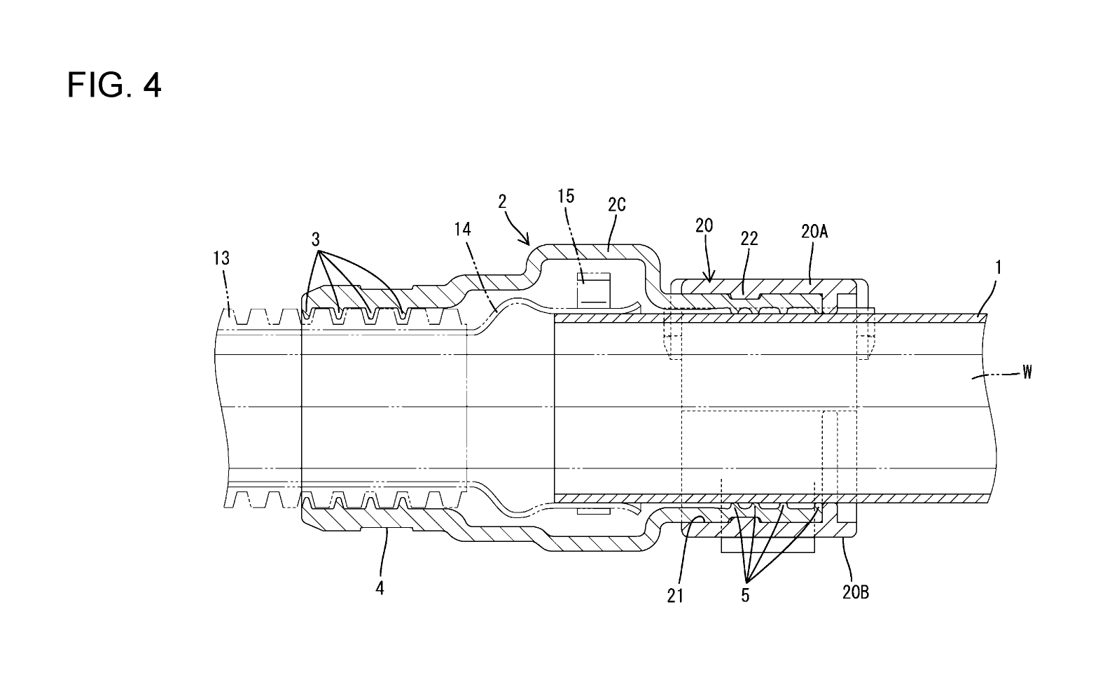

FIG. 4 shows Example 2 of the harness device. A clamp member 20 according to Example 2 has the same basic configuration as the clamp member 6 according to Example 1 but differs in that a pressing rib 22 additionally projects, in a circumferential direction, from the central portion, with respect to the axial direction, of the inner circumferential surface of a tightening portion 21, that is, the inner circumferential surfaces of both divided bodies 20A and 20B. The portion in which the pressing rib 22 is formed corresponds to the region over the two sealing lips 5 positioned on the back side in the region where the sealing lips 5 of the pipe-side connecting portion 2B are formed. The pressing rib 22 can locally increase a tightening force and thus locally improve a sealing force in a state where a tightening portion 21 tightens the portion in which the grommet 2 and the shielding pipe 1 are connected to each other.

With this configuration, the pressing rib 22 projects from a portion of the region where the sealing lips 5 are formed, and therefore, in addition to the effect of Example 1, an effect is exhibited in which a tightening force is locally improved in the pipe-side connecting portion 2B and thus a sealing force is further increased.

### EXAMPLE 3

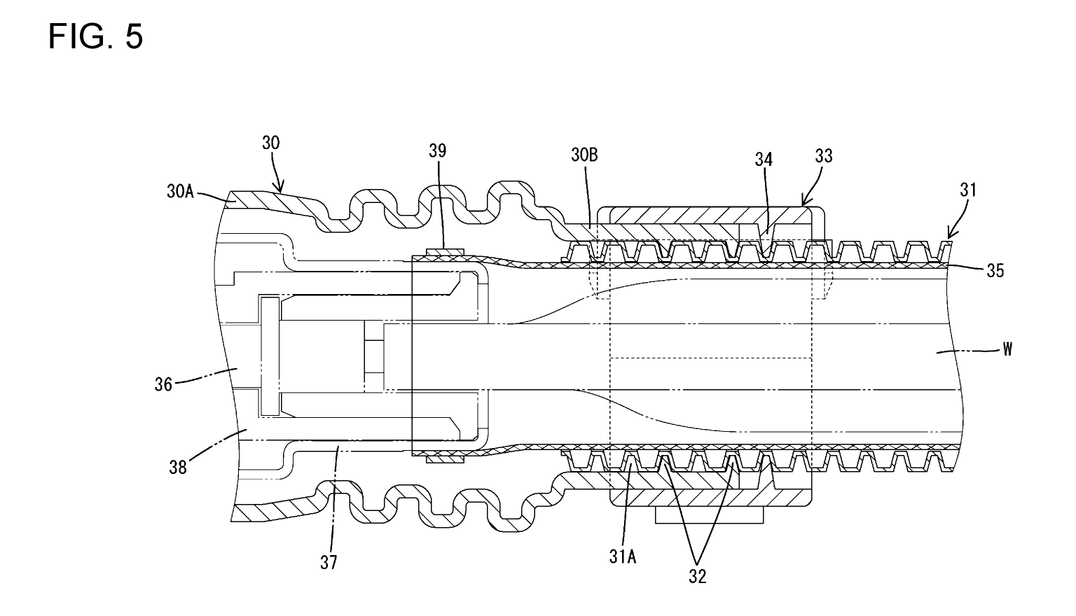

FIG. 5 shows Example 3 of the harness device. Example 3 is used at the portion in which a grommet 30 and a corrugated tube 31 are connected to each other. A braided wire 35 that shields the wire harness W is inserted into the corrugated tube 31. Terminal fittings are connected to the end portions of the high-voltage electric wires constituting the wire harness and are accommodated inside a connector 38 with a shielding case 37. It should be noted that the connector 38 can be connected to a connector on an ECU side (not shown). Moreover, the braided wire 35 and the shielding case 37 are connected with a crimping ring 39.

The corrugated tube 31 is formed in a bellows shape in which a large number of projecting and recessed portions formed along the entire outer circumferential surface are repeated at every fixed pitch. Thereby, favorable flexibility is given to the corrugated tube 31, and the wire harness W constituted by a plurality of electric wires is inserted into it.

A case-side connecting portion 30A is formed on one end side of the grommet 30, and a tube-side connecting portion 30B that is connected to the corrugated tube 31 is formed on the other end side. Two sealing lips 32 shown in the drawing are formed on the inner circumferential surface of the tube-side connecting portion 30B. One sealing lip 32 is disposed at the open end of the tube-side connecting portion 30A, and the other sealing lip 32 is disposed slightly backward from the one sealing lip 32. Both sealing lips 32 are fitted into the corresponding recessed portions 31A with one valley portion 31A of the corrugated tube 31 intervening therebetween, and come into intimate contact with the bottom surfaces of the valley portions 31A to secure a sealing performance.

A clamp member 33 has the substantially same basic configuration as that of Example 1 but differs in that a positioning rib 34 that is locked to the valley portion 31A of the corrugated tube 31 projects instead of the protecting portion 11 of Example 1. The positioning rib 34 is formed at the position located slightly inside from the side ends of first and second divided bodies 33A and 33B.

In this manner, with Example 3, the positioning rib 34 is locked utilizing the projecting and recessed shape of the corrugated tube 31, and therefore, an effect is exhibited in which the clamp member 33 can tighten the portion in which the corrugated tube 31 and the grommet 30 are connected to each other in a state where the clamp member 33 is positioned.

### EXAMPLE 4

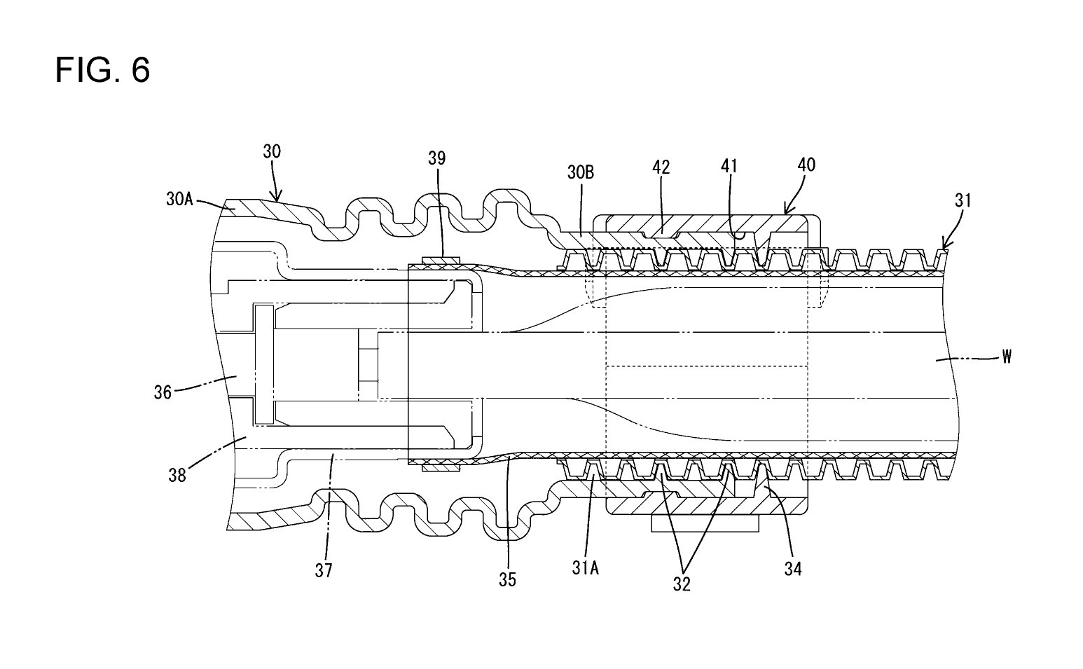

FIG. 6 shows Example 4 of the harness device. Example 4 has the substantially same basic configuration as Example 3 but differs only in that a pressing rib 42 projects from the inner circumferential surface of a tightening portion 41 of a clamp member 40 in the circumferential direction. The pressing rib 42 is disposed in correspondence to the sealing lip 32 on the back side of the two sealing lips 32 formed in the tube-side connecting portion 30B of the grommet 30. The pressing rib 42 presses against the outer circumferential surface of the tube-side connecting portion 30B in a state where the clamp member 40 is attached thereto, and compresses the corresponding sealing lip 32 to locally increase a sealing force.

The other configuration is the same as that of Example 3, and therefore, the same effect can be exhibited.

### OTHER EXAMPLES

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying inventive principles. For example, the following variations are also possible. (1) Although, in the above examples, the first and second divided bodies 6A and 6B, 20A and 20B, and 33A and 33B are connected to each other with the hinge edge 7 in the clamp members 6, 20 and 33, they may be separated without connecting to each other to form separate members.

(2) In Example 1, the protecting portion 11 is formed at a position located inside from the side end of the clamp member 6, but may be formed on the side edge. Thereby, it is possible to prevent high-pressure washing water from infiltrating into the inside of the clamp member 6 and acting in a direction in which the first and second divided bodies 6A and 6B are separated.

(3) Although, in the above examples, the grommets 2 and 30, both of which are made of rubber, are used as connecting partners of the shielding pipe 1 and the corrugated tube 31, respectively, the connecting partners are not necessarily limited to the grommets 2 and 30, and a sealing performance is not necessarily required in the connecting portion of the harness device.

What is claimed is:

1. A harness device comprising:
a first member;
a second member that is fitted onto and connected to an outer circumferential side of the first member;
a wire harness that is inserted into an inside of the first and second members; and
a clamp member that tightens the first member and the second member at a portion where the first and second members are connected, the clamp member being provided with an attaching portion that is configured to be fixed to an installation surface on which the first member and the second member are installed.

2. The harness device according to claim 1, wherein the clamp member includes:
a first divided body;
a second divided body, the first divided body and the second divided body being connected with a hinge; and
a tightening portion that surrounds an entire outer circumferential portion of the second member at the portion in which the first member and the second member are connected when the first and second divided bodies are united, and wherein the hinge is configured to open and close the tightening portion.

3. The harness device according to claim 2, wherein the second member is formed of a rubber material, and includes:
an inner circumferential surface;
an outer circumferential surface; and
a plurality of sealing lips that are formed on the inner circumferential surface of the second member come into intimate contact with the outer circumferential surface of the first member.

4. The harness device according to claim 2, wherein the clamp member includes a protecting portion that covers an end surface of the second member in a circumferential direction is formed at a position that is located on an inner circumferential surface of the tightening portion of the clamp member and projects from an end surface of the second member outwardly in an axial direction.

5. The harness device according to claim 3, wherein the clamp member includes a rib that presses against an outer circumferential surface of the second member is formed in a circumferential direction in a region where the sealing lips are formed on the inner circumferential surface of the tightening portion.

6. The harness device comprising:
a shielding pipe, the shielding pipe having an outer circumferential surface;
a grommet that is disposed on an outer circumferential surface of the shielding pipe;
a connecting portion where the shielding pipe and the grommet are connected;
a wire harness that is inserted into the shielding pipe; and
a clamp that tightens the shielding pipe and the grommet at the connecting portion, the clamp being provided with an attaching portion that is configured to be fixed to an installation surface on which the shielding pipe and the grommet are installed.

7. The harness device according to claim 6, wherein the grommet is formed of a rubber material and includes:
an inner circumferential surface,
an outer circumferential surface, and
a plurality of sealing lips that are formed on the inner circumferential surface of the grommet contact the outer circumferential surface of the shielding pipe.

8. The harness device according to claim 7, wherein the clamp includes a protecting portion that covers an end surface of the grommet.

9. The harness device according to claim 7, wherein the clamp includes a pressing rib that presses against the outer circumferential surface of the grommet.

10. A clamp for tightening a connection between a shielding pipe and a grommet, the clamp comprising:
a first divided body;
a second divided body, the first divided body and the second divided body being connected by a hinge; and
an attaching portion that is configured to be fixed to an installation surface on which the shielding pipe and the grommet are installed.

11. The clamp according to claim 10, wherein the first divided body further comprises a locking jaw.

12. The clamp according to claim 11, wherein the attaching portion further comprises lock receiving portions that are configured to receive the locking jaw.

13. The clamp according to claim 12, wherein the protecting portion is configured to press against the grommet, and is disposed on one side of the first divided body and one side of the second divided body.
